(19) United States
(12) Patent Application Publication
(10) Pub. No.: US 2024/0213565 A1
(43) Pub. Date: Jun. 27, 2024

(54) THERMAL MITIGATION SYSTEMS FOR TRACTION BATTERY PACKS

(71) Applicant: FORD GLOBAL TECHNOLOGIES, LLC, Dearborn, MI (US)

(72) Inventors: Bhaskara Rao Boddakayala, Troy, MI (US); Eric Poirier, Brownstown, MI (US)

(21) Appl. No.: 18/069,254

(22) Filed: Dec. 21, 2022

(51) Int. Cl. H01M 10/625; H01M 10/48; H01M 10/613; H01M 10/6561; H01M 50/342

(52) U.S. Cl. CPC H01M 10/625; H01M 10/486; H01M 10/613; H01M 10/6561; H01M 50/3425; H01M 2200/20; H01M 2220/20

(57) ABSTRACT

Thermal mitigation systems are provided for traction battery packs. An exemplary thermal mitigation system may include a cartridge containing a nitrogen releasing material, and a heating element. The heating element may be activated to cause the nitrogen releasing material to release a nitrogen gas for actively mitigating battery thermal events. Another exemplary thermal mitigation system may include one or more passive release devices that are mounted to a battery array. A nitrogen releasing material may be activated via heat generated within the battery array to release a nitrogen gas from a polymeric encapsulating material of the passive release device to passively mitigate battery thermal events.

### TECHNICAL FIELD

This disclosure relates generally to traction battery packs, and more particularly to thermal mitigation systems for mitigating battery thermal events within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A thermal mitigation system for a traction battery pack according to an exemplary aspect of the present disclosure includes, among other things, a cartridge containing a nitrogen releasing material, a heating element housed within the cartridge, and a controller configured to control the heating element for causing the nitrogen releasing material to release a nitrogen gas when a temperature within the traction battery pack exceeds a predefined temperature threshold.

In a further non-limiting embodiment of the foregoing thermal mitigation system, the nitrogen releasing material includes guanidine nitrate (C(NH₂)₃NO₃).

In a further non-limiting embodiment of either of the foregoing thermal mitigation systems, the nitrogen releasing material includes sodium azide (NaN₃).

In a further non-limiting embodiment of any of the foregoing thermal mitigation systems, the cartridge includes a vent patch that is configured to open to release the nitrogen gas when a pressure inside the cartridge exceeds a predefined pressure threshold.

In a further non-limiting embodiment of any of the foregoing thermal mitigation systems, the vent patch is comprised of a different material than the cartridge.

In a further non-limiting embodiment of any of the foregoing thermal mitigation systems, the vent patch includes polytetrafluoroethylene (PTFE), and the cartridge includes a polycarbonate.

In a further non-limiting embodiment of any of the foregoing thermal mitigation systems, a desiccant is housed within the cartridge.

In a further non-limiting embodiment of any of the foregoing thermal mitigation systems, the controller is a 12V controller circuit that is independent or part of a battery management system of the traction battery pack.

In a further non-limiting embodiment of any of the foregoing thermal mitigation systems, the cartridge is comprised of a polycarbonate.

In a further non-limiting embodiment of any of the foregoing thermal mitigation systems, the nitrogen releasing material is configured to decompose to release the nitrogen gas.

In a further non-limiting embodiment of any of the foregoing thermal mitigation systems, a thermal sensing device is mounted to a battery array of the traction battery pack and is configured to detect the temperature within the battery array.

In a further non-limiting embodiment of any of the foregoing thermal mitigation systems, the thermal sensing device is a thermistor or a thermocouple.

In a further non-limiting embodiment of any of the foregoing thermal mitigation systems, a passive release device is mounted to a battery array of the traction battery pack.

In a further non-limiting embodiment of any of the foregoing thermal mitigation systems, the passive release device includes a polymeric encapsulating material and a nitrogen releasing material encapsulated within the polymeric encapsulating material.

In a further non-limiting embodiment of any of the foregoing thermal mitigation systems, the nitrogen releasing material is configured to release a nitrogen gas when the temperature within the traction battery pack exceeds the predefined temperature threshold.

A thermal mitigation system for a traction battery pack according to another exemplary aspect of the present disclosure includes, among other things, a battery array, and a passive release device mounted to the battery array. The passive release device includes a polymeric encapsulating material and a nitrogen releasing material encapsulated within the polymeric encapsulating material. The nitrogen releasing material is configured to release a nitrogen gas when a temperature within the traction battery pack exceeds a predefined temperature threshold.

In a further non-limiting embodiment of the foregoing thermal mitigation system, the nitrogen releasing material includes guanidine nitrate (C(NH₂)₃NO₃).

In a further non-limiting embodiment of either of the foregoing thermal mitigation systems, the polymeric encapsulating material is configured as a polyethylene laminated pouch.

In a further non-limiting embodiment of any of the foregoing thermal mitigation systems, the polymeric encapsulating material is configured to break open to release the nitrogen gas when a pressure inside the polymeric encapsulating structure exceeds a predefined pressure threshold.

In a further non-limiting embodiment of any of the foregoing thermal mitigation systems, the passive release device is mounted to a battery cell or an array support structure of the battery array.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates select portions of a traction battery pack that includes a thermal mitigation system.

FIG. 3 schematically illustrates an exemplary thermal mitigation system of a traction battery pack.

FIG. 4 illustrates the thermal mitigation system of FIG. 3 during a battery thermal event of a traction battery pack.

FIG. 5 illustrates another exemplary thermal mitigation system for a traction battery pack.

FIG. 6 illustrates an exemplary mounting location of a passive release device of the thermal mitigation system of FIG. 5.

FIG. 7 illustrates an exemplary passive release device of the thermal mitigation system of FIG. 5.

FIG. 8 illustrates the passive release device of FIG. 7 during a battery thermal event of a traction battery pack.

FIG. 9 illustrates yet another exemplary thermal mitigation system for a traction battery pack.

### DETAILED DESCRIPTION

This disclosure details thermal mitigation systems for traction battery packs. An exemplary thermal mitigation system may include a cartridge containing a nitrogen releasing material and a heating element. The heating element may be activated to cause the nitrogen releasing material to release a nitrogen gas for actively mitigating battery thermal events. Another exemplary thermal mitigation system may include one or more passive release devices that are mounted to a battery array. A nitrogen releasing material may be activated via heat generated within the battery array to release a nitrogen gas from a polymeric encapsulating material of the passive release device to mitigate battery thermal events. These and other features are discussed in greater detail in the following paragraphs of this detailed description.

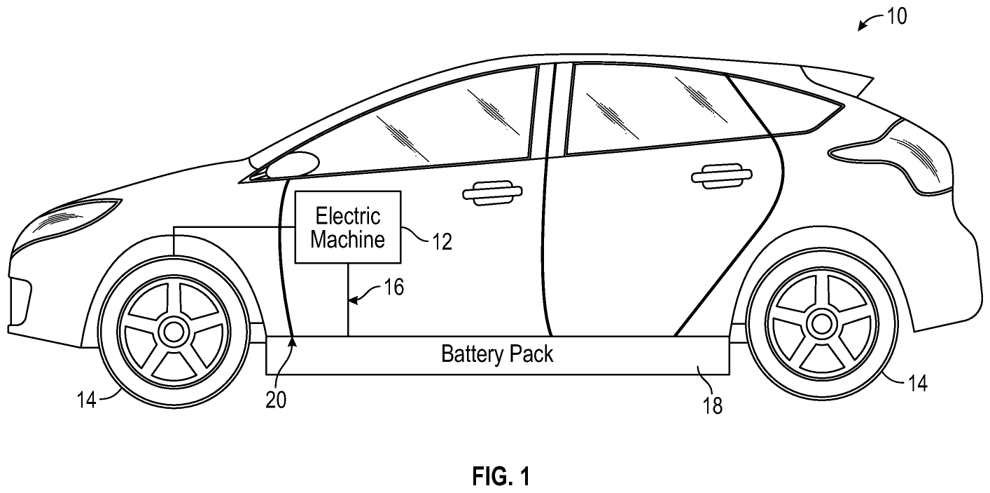

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

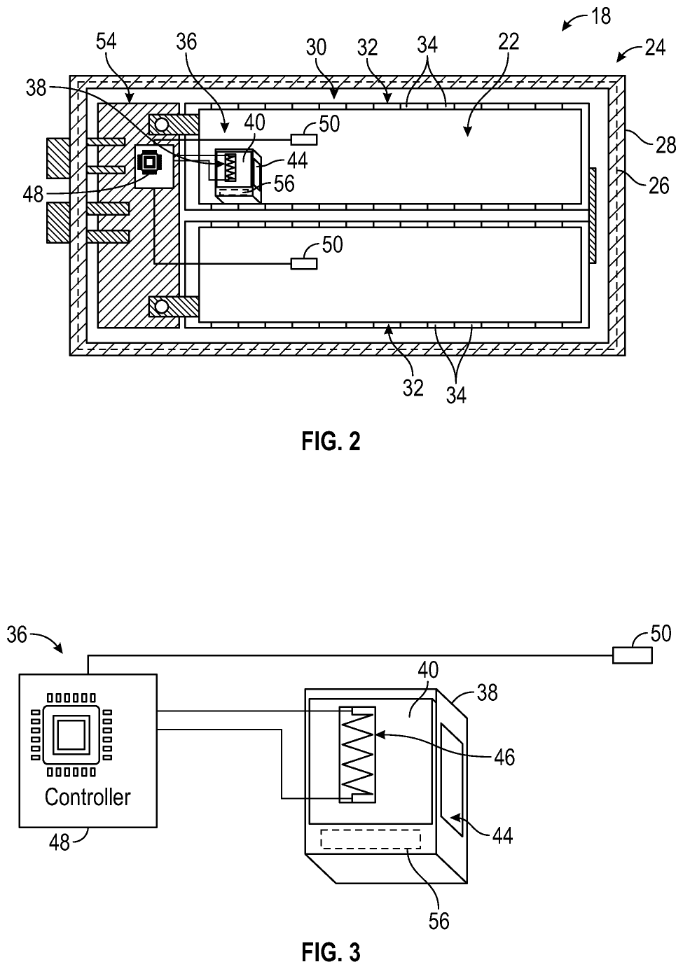

Referring now to FIG. 2, the traction battery pack 18 may include a battery system 22 housed within an interior area 30 of an enclosure assembly 24. The enclosure assembly 24 of the traction battery pack 18 may include an enclosure cover 26 (shown in phantom) and an enclosure tray 28. The enclosure cover 26 may be secured (e.g., bolted, welded, adhered, etc.) to the enclosure tray 28 to provide the interior area 30 for housing the battery system 22.

The battery system 22 may include one or more battery arrays 32 (e.g., groupings of battery cells 34) arranged within the interior arear 30. Once electrically coupled, the battery cells 34 of the battery arrays 32 may supply electrical power for powering various components of the electrified vehicle 10. Although two battery arrays 32 are shown, the battery system 22 could include one or more battery arrays 32 within the scope of this disclosure. Thus, the total number of battery cells 34 included as part of the battery system 22 is not intended to limit this disclosure.

In an embodiment, the battery cells 34 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

From time to time, one or more battery cells 34 of the traction battery pack 18 can experience a battery thermal event in which pressure and thermal energy of the one or more battery cells 34 increases. The pressure and thermal energy increase can be due to an overcharge condition, an overdischarging condition, or a short circuit event, for example. The pressure and thermal energy increase can cause the battery cell 34 experiencing the thermal event to release gas and/or effluents. The gases may be released as a result of an applied force or a thermal event, and can either cause or exacerbate an existing battery thermal event. A relatively significant amount of heat can be generated during battery thermal events, and this heat can sometimes cascade from array-to-array and/or cell-to-cell within the traction battery pack 18/array. The traction battery pack 18 may therefore be equipped with a thermal mitigation system 36 for mitigating the effects of battery thermal events.

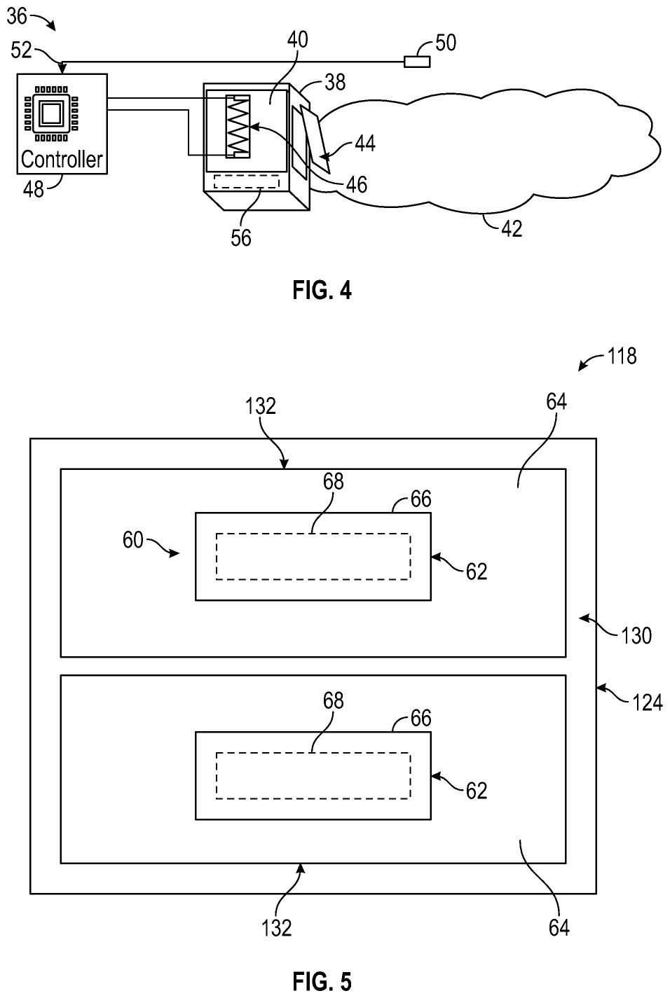

An exemplary thermal mitigation system 36 for use within the traction battery pack 18 is further illustrated with reference to FIGS. 3 and 4 (with continued reference to FIG. 2). As discussed in greater detail below, the thermal mitigation system 36 may actively respond to a battery thermal event (e.g., by releasing nitrogen (N2) gas) when a temperature within the traction battery pack 18 exceeds a predefined temperature threshold.

The thermal mitigation system 36 may include one or more cartridges 38 that house a nitrogen releasing material 40. The cartridge 38 may be mounted at any location inside the enclosure assembly 24 of the traction battery pack 18. In an embodiment, the cartridge 38 includes a box-like or cuboid shape. However, the size and the shape of the cartridge 38 are not intended to limit this disclosure.

The cartridge 38 may be made of a plastic material. In an embodiment, the plastic material includes polycarbonate. However, other plastic materials may also be suitable for constructing the cartridge 38.

The nitrogen releasing material 40 may be contained inside the cartridge 38 during normal operation of the traction battery pack 18 (see FIG. 3). The nitrogen releasing material 40 may be a sheet or a film or could take any other form or geometry. The nitrogen releasing material 40 may be selectively activated to release a nitrogen (N2) gas 42 from the cartridge 38 (see FIG. 4). The nitrogen releasing material 40 may be activated by being heated to a temperature that exceeds its decomposition temperature (e.g., about 240 degrees C.). In this disclosure, the term “about” means that the expressed quantities or ranges need not be exact but may be approximated and/or larger or smaller, reflecting acceptable tolerances, conversion factors, measurement error, etc. The released N2 gas 42 reduces the oxygen content inside the traction battery pack 18, thereby hindering combustion and actively mitigating battery thermal events when the temperature within the traction battery pack 18 exceeds the predefined temperature threshold.

In an embodiment, the nitrogen releasing material 40 includes guanidine nitrate (C(NH₂)₃NO₃), which is a colorless, water-soluble salt. In another embodiment, the nitrogen releasing material 40 includes sodium azide (NaN₃), which is another colorless, water-soluble salt. Other nitrogen releasing materials may also be suitable within the scope of this disclosure.

The N2 gas 42 may be released from the cartridge 38 through a vent patch 44. The vent patch 44 may open when a pressure inside the cartridge 38 exceeds a predefined pressure threshold. In an embodiment, the vent patch 44 is made of a non-permeable polymer film that is configured to rupture when the pressure inside the cartridge 38 exceeds the predefined pressure threshold. An exemplary non-permeable polymer film may include polytetrafluoroethylene (PTFE). However, other materials may also be utilized as part of the construction of the vent patch 44 within the scope of this disclosure.

The release of the N2 gas 42 from the cartridge 38 may be controlled by a heating element 46 and a controller 48. The heating element 46 may be packaged inside the cartridge 38 and is operably connected to the controller 48. In an embodiment, the heating element 46 includes a metallic wire (e.g., nichrome) that is encapsulated in a polyamide film (e.g., Kapton®). However, other heating elements are also contemplated.

One or more thermal sensing devices 50 may also be operably connected to the controller 48. In an embodiment, one thermal sensing device 50 is mounted on or in the direct vicinity of one of the battery arrays 32 (see FIG. 2) of the traction battery pack 18 and is configured to monitor a temperature of the respective battery array 32, or a temperature of the air near the respective battery array 32. In an embodiment, the thermal sensing devices 50 are thermistors. In another embodiment, the thermal sensing devices 50 are linear heat detection devices that are designed to short in the presence of heat. In yet another embodiment, the thermal sensing devices 50 are flex film thermocouples.

The thermal sensing devices 50 may be designed to communicate a signal 52 to the controller 48 when the temperature within the traction battery pack 18 exceeds the predefined temperature threshold. Temperatures that exceed the predefined temperature threshold may be indicative of battery thermal events. The controller 48 may thus be configured to detect overtemperature conditions of the traction battery pack 18 based on the signals 52 received from the thermal sensing devices 50. When the detected temperature of one or more battery arrays 32 or the air near the arrays exceeds the predefined temperature threshold, the controller 48 may command that a current be sent to the heating element 46 that causes the heating element 46 to begin generating heat. The heat induces the nitrogen releasing material 40 to generate the N2 gas 42, which thereby causes the pressure inside the cartridge 38 to rapidly increase. When the pressure increases beyond the predefined pressure threshold of the vent patch 44, the vent patch 44 may break open and release the N2 gas into the interior area 30 of the traction battery pack 18 (or an interior area of battery array 32) for mitigating the battery thermal event. For example, the N2 gas may reduce the oxygen content inside the traction battery pack 18, and in so doing, reduce temperatures and/or reduce the array-to-array transfer of heat within the traction battery pack 18.

The nitrogen releasing material 40 may be a moisture sensitive material. Therefore, a desiccant 56 may additionally be housed within the cartridge 38. The desiccant 56 may be configured to absorb water molecules from surrounding air and thus decrease the overall moisture level inside the cartridge 38. The desiccant 56 may include silicone dioxide or any other suitable absorption or adsorption material.

In some implementations, the controller 48 may be a 12V controller circuit of a battery management system (BMS) 54 (see FIG. 2) of the traction battery pack 18. In other implementations, the controller 48 may be a stand alone control unit operable to communicate with the BMS 54 as part of a control system of the traction battery pack 18. The controller 48 may therefore be programmed with instructions for controlling certain aspects of the thermal mitigation system 36.

FIG. 5 illustrates another exemplary thermal mitigation system 60 for a traction battery pack 118. In this implementation, the thermal mitigation system 60 may be passive system that does not require the use of a controller for mitigating the effects of battery thermal events. As discussed in greater detail below, the thermal mitigation system 60 may actively mitigate battery thermal events by releasing N2 gas when a temperature within the traction battery pack 118 exceeds a predefined temperature threshold.

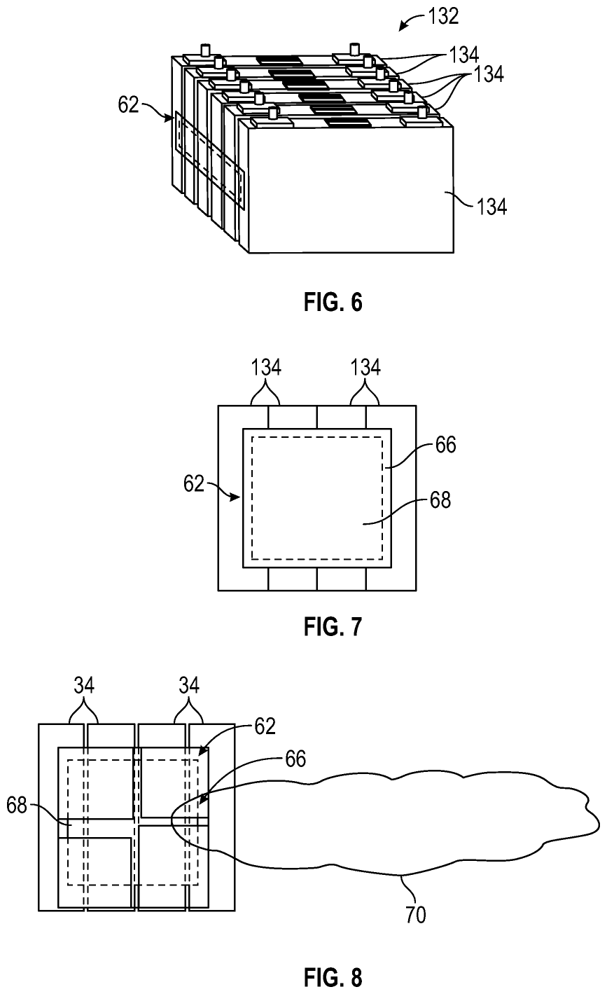

The thermal mitigation system 60 may include one or more passive release devices 62. One or more of the passive release device 62 may be mounted directly to each battery array 132 of the traction battery pack 118. The one or more passive release devices 62 may be mounted directly to an array support structure 64 (e.g., a top plate, side plate, end plate, etc.) of each battery array 132 (see FIG. 5), or the one or more passive release devices 62 could be mounted directly to one or more battery cells 134 of each battery array 132 (see FIG. 6). The battery arrays 132 may be positioned within an interior area 130 established by an enclosure assembly 124 of the traction battery pack 118.

An exemplary passive release device 62 of the thermal mitigation system 60 is further illustrated with reference to FIGS. 7 and 8 (with continued reference to FIGS. 5-6). The passive release device 62 may include a polymeric encapsulating material 66 and a nitrogen releasing material 68 encapsulated within the polymeric encapsulating material 66.

In an embodiment, the polymeric encapsulating material 66 is configured as a polyethylene laminated pouch. However, other geometries and materials are contemplated within the scope of this disclosure, and therefore the size, shape, and material make-up of the polymeric encapsulating material 66 is not intended to limit this disclosure.

The nitrogen releasing material 68 may be contained inside the polymeric encapsulating material 66 during normal operation of the traction battery pack 118 (see FIG. 7). The nitrogen releasing material 68 may be a sheet or a film or could take any other form or geometry. The nitrogen releasing material 68 may be selectively activated to release a nitrogen (N2) gas 70 from the polymeric encapsulating material 66 (see FIG. 8). For example, when a predefined temperature threshold inside the traction battery pack 118 is reached, the nitrogen releasing material 68 may decompose to release the N2 gas 70. The release of the N2 gas 70 causes a pressure build-up within the polymeric encapsulating material 66. When the pressure exceeds a predefined pressure threshold of the polymeric encapsulating material 66, the polymeric encapsulating material 66 may break open and allow the N2 gas 70 to escape into the traction battery pack 118. The released N2 gas 70 reduces the oxygen content inside the traction battery pack 118, thereby hindering combustion and mitigating the effects of battery thermal events.

In an embodiment, the nitrogen releasing material 68 includes guanidine nitrate (C(NH₂)₃NO₃). In another embodiment, the nitrogen releasing material 68 includes sodium azide (NaN₃). Other nitrogen releasing materials may also be suitable within the scope of this disclosure.

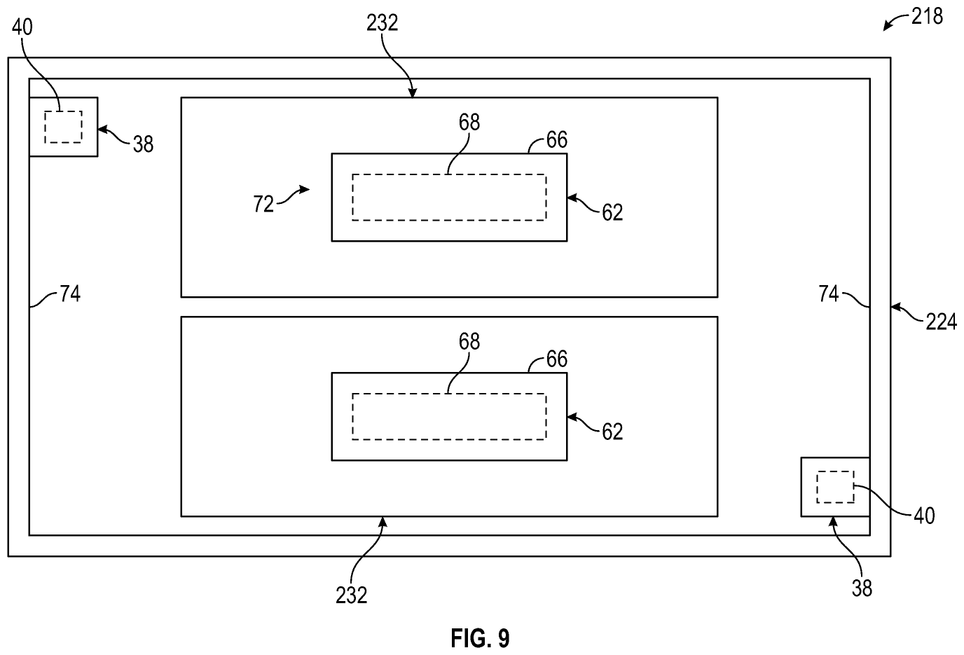

FIG. 9 illustrates another exemplary thermal mitigation system 72 for a traction battery pack 218. In this embodiment, the thermal mitigation system 72 may include a combination of the cartridges 38 that house the nitrogen releasing material 40 and the passive release devices 62. The passive release devices 62 may be mounted in physical contact with battery arrays 232 of the traction battery pack 218, and the cartridges 38 may be mounted remote from the battery arrays 232, such as to an interior wall 74 of an enclosure assembly 224 of the traction battery pack 218, for example.

The exemplary thermal mitigation systems of this disclosure are capable of rapidly releasing nitrogen gas in order to hinder combustion during battery thermal events. The proposed systems are simple to install yet effective at limiting the effects of battery thermal events.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A thermal mitigation system for a traction battery pack, comprising:
a cartridge containing a nitrogen releasing material;
a heating element housed within the cartridge; and
a controller configured to control the heating element for causing the nitrogen releasing material to release a nitrogen gas when a temperature within the traction battery pack exceeds a predefined temperature threshold.

2. The thermal mitigation system as recited in claim 1, wherein the nitrogen releasing material includes guanidine nitrate (C(NH₂)₃NO₃).

3. The thermal mitigation system as recited in claim 1, wherein the nitrogen releasing material includes sodium azide (NaN₃).

4. The thermal mitigation system as recited in claim 1, wherein the cartridge includes a vent patch that is configured to open to release the nitrogen gas when a pressure inside the cartridge exceeds a predefined pressure threshold.

5. The thermal mitigation system as recited in claim 4, wherein the vent patch is comprised of a different material than the cartridge.

6. The thermal mitigation system as recited in claim 5, wherein the vent patch includes polytetrafluoroethylene (PTFE), and the cartridge includes a polycarbonate.

7. The thermal mitigation system as recited in claim 1, comprising a desiccant housed within the cartridge.

8. The thermal mitigation system as recited in claim 1, wherein the controller is a 12V controller circuit that is independent or part of a battery management system of the traction battery pack.

9. The thermal mitigation system as recited in claim 1, wherein the cartridge is comprised of a polycarbonate.

10. The thermal mitigation system as recited in claim 1, wherein the nitrogen releasing material is configured to decompose to release the nitrogen gas.

11. The thermal mitigation system as recited in claim 1, comprising a thermal sensing device mounted to a battery array of the traction battery pack and configured to detect the temperature within the battery array.

12. The thermal mitigation system as recited in claim 11, wherein the thermal sensing device is a thermistor or a thermocouple.

13. The thermal mitigation system as recited in claim 1, comprising a passive release device mounted to a battery array of the traction battery pack.

14. The thermal mitigation system as recited in claim 13, wherein the passive release device includes a polymeric encapsulating material and a nitrogen releasing material encapsulated within the polymeric encapsulating material.

15. The thermal mitigation system as recited in claim 14, wherein the nitrogen releasing material is configured to release a nitrogen gas when the temperature within the traction battery pack exceeds the predefined temperature threshold.

16. A thermal mitigation system for a traction battery pack, comprising:
a battery array; and
a passive release device mounted to the battery array,
wherein the passive release device includes a polymeric encapsulating material and a nitrogen releasing material encapsulated within the polymeric encapsulating material,
wherein the nitrogen releasing material is configured to release a nitrogen gas when a temperature within the traction battery pack exceeds a predefined temperature threshold.

17. The thermal mitigation system as recited in claim 16, wherein the nitrogen releasing material includes guanidine nitrate (C(NH₂)₃NO₃).

18. The thermal mitigation system as recited in claim 16, wherein the polymeric encapsulating material is configured as a polyethylene laminated pouch.

19. The thermal mitigation system as recited in claim 16, wherein the polymeric encapsulating material is configured to break open to release the nitrogen gas when a pressure inside the polymeric encapsulating structure exceeds a predefined pressure threshold.

20. The thermal mitigation system as recited in claim 16, wherein the passive release device is mounted to a battery cell or an array support structure of the battery array.
